(19) United States
(12) Patent Application Publication
(10) Pub. No.: US 2002/0144955 A1
(43) Pub. Date: Oct. 10, 2002

(54) Method and system for purifying water contained in a vessel

(76) Inventors: Menashe Barak, Haifa (IL); Ziv Karni, Kfar Shemaryhu (IL)

Correspondence Address: BROWDY AND NEIMARK, P.L.L.C., 624 NINTH STREET, NW, SUITE 300, WASHINGTON, DC, 20001-5303, US

(21) Appl. No.: 09/783,290

(22) Filed: Feb. 15, 2001

(51) Int. Cl. B03C 1/00

(52) U.S. Cl. 210/748

(57) ABSTRACT

A water purification method and system, wherein a source of ultraviolet light is disposed relative to the vessel containing the water to be purified for directing ultraviolet light along a major axis of the vessel, and the water is illuminated with the ultraviolet light. One of the systems includes a vessel containing the water to be purified, at least one ultraviolet lamp, external to the vessel, and at least one collimaor for collimating ultraviolet light radiated by the at least one lamp, wherein the light illuminates the water along a major axis of the vessel, Preferably, the lamp can be operated in one or more of the following three modes: continuous constant intensity; quasi cw intensity; and/or pulsed intensity.

### FIELD OF THE INVENTION

This invention relates to water purification

### BACKGROUND OF THE INVENTION

It is generally well known that it is necessary to kill or inactivate micro-organism (e.g. bacteria, viruses) to purit water. One method of killing or inactivating bacteria and viruses is through the usage of ultraviolet light (UV). Prior art UV systems use a single or multiple longitudinal mercury (Hg) lamps which are either low or medium pressure. Refer to prior art FIG. 1 which shows a low pressure Hg lamp system 10. A lamp 12 is enclosed by a protective quartz sleeve 14 and the assembly of lamp 12 and quartz sleeve 14 is immersed in a treatment chamber 16. The water 20 flows parallel to the major axis of lamp 12. The light 18 from lamp 12 (caused by the excited Hg) radiates perpendicular to the major axis of lamp 12 and the intesity of light 18 drops as 1/x. The variable x ranges from 0 to R, where R is the radial distance from lamp 12 to the wall of treatment chamber 16. The intensity per is unit area relationship can be described as:

$$I ( x ) = {I}_{0} [ {e}^{- ax} - \frac{1}{x} ]$$

where:

Iₒ is the intensity of light 18 per unit area on the envelope of lamp 12;

I is the intensity of light 18 per unit area at a distance x from lamp 12 along the radial distance; and

A is the absorption coefficient of water 20 (including turbidity)

The second factor Io/x, which is due to geometrical considerations contributes more significantly to the intensity drop and limits effective light penetration more than the first factor Iₒe^{-ax} which is based on the Bear-Lambert's law.

Prior art FIG. 2 shows the intensity profile of lamp 12 as a function of x.

The limitations of prior art UV systems include: a) the associated maintenance cost for cleaning the quartz sleeve 14 from contamination by water deposit such as salts; b) the inefficiency in treating high turbidity water sources—with higher turbidity, one needs higher power to effect purification, however the level of penetration of light 18 is reduced due to the intensity drop as a function of radial distance; c) the large footprint (i.e. system size); d) the low electrical efficiency—because of the drop of intensity as a function of radial distance, one needs to increase lamp radiation so as to reach the minimum required intensity at a desired distance from lamp 12; and in certain systems e) the large number of lamps needed for sufficient radiation.

All of the drawbacks listed above are encountered with conventional low-pressure longitudinal Hg UV lamps, and generally discourage consideration of UV for treating very high volume effluents.

The more advanced systems use medium pressure Hg lamps with a continuum and poly-spectral emission in the range of 200-300 nanometers (“nm”). Medium pressure systems have smaller footprint and better electrical efficiency—but still are housed by quartz envelops which require frequent service.

In a paper by LaFrenz entitled “High Intensity Pulsed UV for Drinking Water Treatment”, Proc. AWWA WQT Conference, Denver, Colo., November 1997, a pulsed system for drinking water treatment is described. The system uses a medium pressure longitudinal mercury lamp located inside the processing chamber, which provides about 2 times the peak power in pulsed operation than in DC operation.

### SUMMARY OF THE INVENTION

It is an object of the invention to overcome the inherent limitations of prior art UV systems.

It is another object of the invention to eliminate the need for a protective quartz sleeve.

It is yet another object of the invention to increase the efficiency of the water treatment by lowering the intensity drop per unit area.

It is yet another object of the invention to increase the efficiency of the water treatment through the delivery of higher peak power in a quasi cw mode or a pulsed operation.

It is yet another object of the invention to increase the efficiency of the water treatment, by introducing strong turbulence and mixing action in the irradiated zone, with minimal blocking and/or interfering with the passage of the UV radiation.

A preferred embodiment of the system of the present invention includes a collimated high pressure Hg-Xe lamp (continuum plus poly-spectra in the 200-300 nm range) which is external to the processing chamber. A single lamp can deliver up to five kW in average electrical power.

According to the present invention, there is provided a method for purifying water contained in a vessel, including the steps of disposing a source of ultraviolet light relative to the vessel for directing ultraviolet light along a major axis of the vessel; and illuminating the water with the ultraviolet light.

According to the present invention, there is also provided a water purification system, including: a vessel containing the water to be purified; at least one ultraviolet lamp, external to the vessel; and at least one collimator for collimating ultraviolet light radiated by the at least one lamp; wherein the light illuminates the water along a major axis of the vessel.

According to the present invention, there is still further provided a water purification system, including: a vessel containing the water to be purified and including an inner chamber, wherein the inner chamber includes rotating fins for increasing turbulence; at least one ultraviolet lamp, external to the vessel; at least one electrical circuit to operate the at least one lamp in pulsed mode; at least one collimator for collimating ultraviolet light radiated by the at least one lamp; and at least one window through which light collimated by the at least one collimator enters the vessel; wherein the light illuminates the water along a major axis of the vessel.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 shows a schematic of a prior art water purification system using a low pressure mercury lamp;

FIG. 2 is an intensity profile for a single lamp in a prior art water purification system;

FIG. 3 illustrates a schematic of a water treatment system according to an embodiment of the present invention;

FIG. 4 shows an entrance window to a processing chamber according to an embodiment of the present invention;

FIG. 5 illustrates a water purification system according to an embodiment of the present invention;

FIG. 6 shows a light beam according to an embodiment of the present invention;

FIG. 7 illustrates a water purification system according to an embodiment of the present invention;

FIG. 8 shows a lamp according to an embodiment of the present invention;

FIG. 9a shows an electrical circuit for continuous constant (cw) operation of the lamp according to an embodiment of the present invention;

FIG. 9b shows an electrical circuit for quasi cw operation of the lamp according to an embodiment of the present invention;

FIG. 9c shows an electrical circuit for pulsed operation of the lamp according to an embodiment of the present invention;

FIG. 10 shows an energy measuring device according to an embodiment of the present invention;

FIG. 11 illustrates a water purification system according to an embodiment of the present invention; and

FIG. 12 illustrates a water purification system according to an embodiment of the present invention.

### DETAILED DESCRIPTION OF THE INVENTION

The present invention is of a water treatment system and method. Specifically, the present invention call be used to more efficiently treat contaminated wastewater.

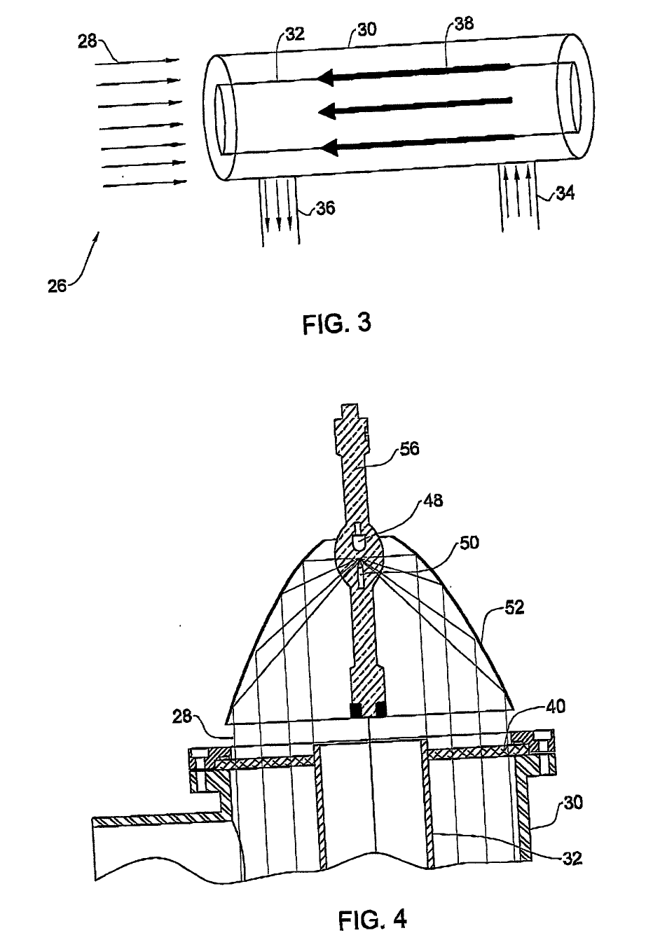

Referring now to the drawings, FIG. 3 illustrates an embodiment of a water treatment system 26 according to the present invention.

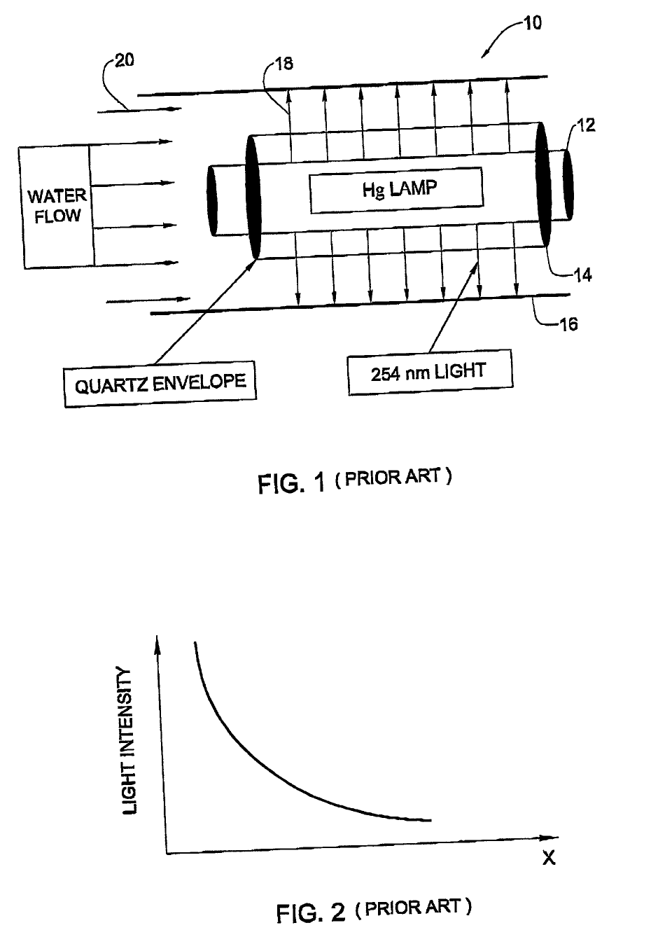

Longitudinal illumination of water 38 in a processing chamber i.e. vessel 30 by a UV beam 28 allows a decreased intensity drop compared to prior art system 10. UV beam 28 enters processing chamber 30 through one or more entrance windows 40 (see FIG. 4), preferably quartz or sapphire window(s), preferably coated with special UV transmitting polymer to avoid contamination. Because of the smaller size of window 40 compared to prior art sleeve 14 of FIG. 1, the contact area with water 38 is smaller. Therefore window 40 is less likely to get contaminated, and there is less cost and time to clean window 40 from contamination compared to sleeve 14. Contaminated water 34 flows into chamber 30 and clean water 36 flows out of chamber 30. Preferably, water 38 is flowing along the major axis of chamber 30. Although in the embodiment of FIG. 3, water 38 flows in the opposite direction of the radiation of light 28, in other embodiments, water 38 flows in the same direction or in both the same and opposite directions as the radiation of light 28.

The intensity drop in system 26 is attributed only to the absorbed and scattered light in the water and the micro-organisms. If Iₒ is the intensity of beam 28 at entrance window 40, then the intensity I(x) of beam 28 at a distance x into chamber 30 is given by:

I(x)=Iₒe^{-at}

where: “a” is the absorption coefficient of water 38 (including turbidity). Note that the larger contributing factor (geometrically related) to the intensity drop of prior art system 10 does not contribute to the intensity drop of system 26, because of the usage of longitudinal illumination instead of transverse illumination.

Using system 26 enables longer interaction time between UV beam 28 and water 38, because of the lower intensity drop. A larger volume of water 38 can therefore be treated with the energy from UV beam 28, thus increasing efficiency compared to prior art system 10.

As an example, the absorption coefficient of clear water at a wavelength of 250 nm for beam 28 is about 200 cm⁻¹. The decrease in beam intensity I(x) is less than 20% on an interaction length of 70 cm. Note that the treated volume of water is equal to the interaction length (from window 40 to maximum distance along the major axis of chamber 30 where intensity remains sufficient to treat water) multiplied by the cross-sectional area of chamber 30.

In order to achieve the longitudinal illumination, in certain embodiments of the present invention, a lamp (external to processing chamber 30) is used along with a collimator. The collimator changes the diverging light from the lamp (which is a point source) to parallel beam 28. Examples of collimators include lenses or reflectors parabolic, spherical, etc.). Typically, reflectors are more efficient collimators than lenses because reflectors collimate light from all directions. In particular, parabolic reflectors are especially efficient collimators.

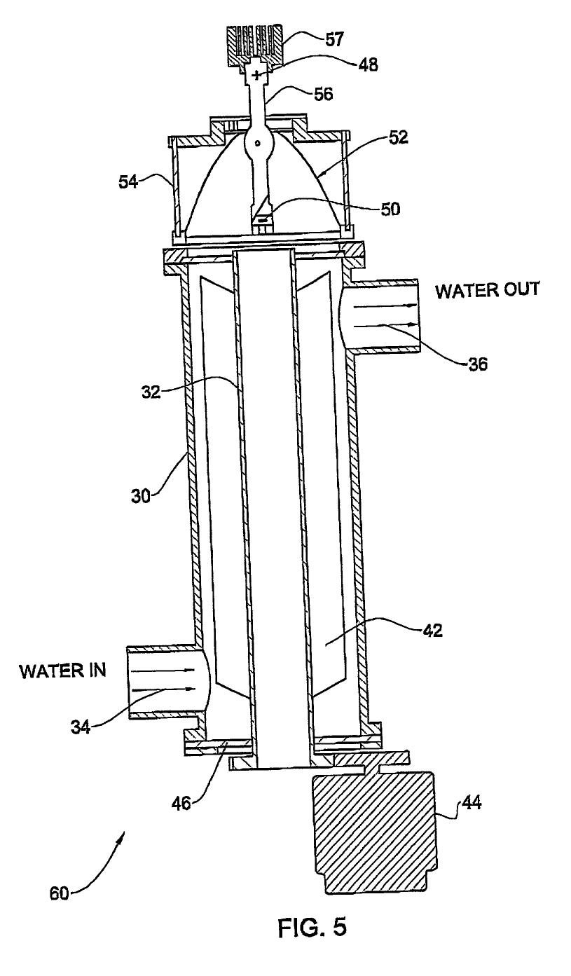

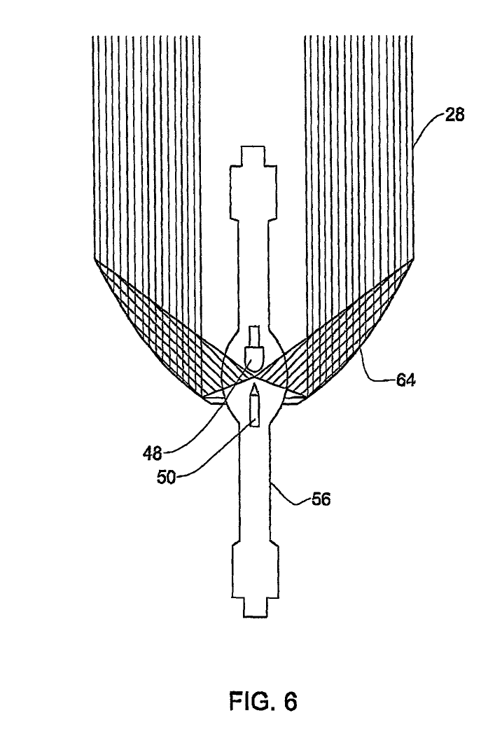

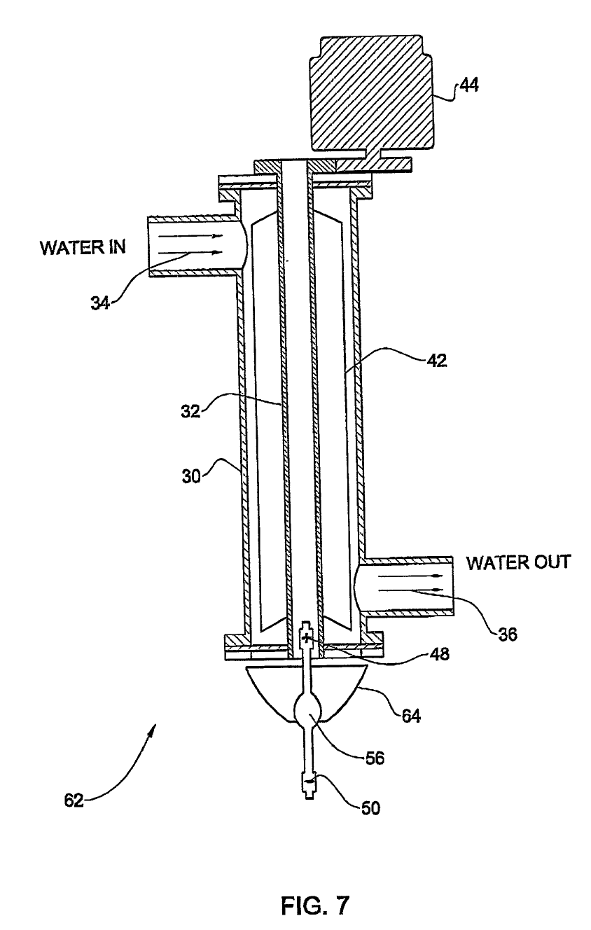

Refer to FIG. 5, which shows a water treatment system 60 that is a particular embodiment of system 26 of FIG. 3. A parabolic mirror 52 is used as a collimator. A lamp 56 is placed at one of the focal points of collimator 52 in the vertical position, illuminating downwards. Because of the presence of lamp 56 within collimator 52, beam 28 is collimated in a ring or doughnut shape (i.e. within the ring of the parallel beam of light, there is a dark inner hole). FIG. 6 illuminates an example of the shape of beam 28 corresponding to the embodiment of FIG. 7.

Referring to FIG. 7, there is illustrated the water treatment system 62 which is a second particular embodiment of the system 26 of FIG. 3 with lamp 56 illuminating upwards.

In preferred embodiments of the present invention, the processing chamber 30 is also ring shaped so as to conform to the ring shape of beam 28. There is no water 38 (FIG. 3) contained in an inner chamber 32. Window 40 (FIG. 4) therefore does not need to provide an opening to inner chamber 32-note that window 40 in the embodiment of FIG. 4 only exists on the sides of inner chamber 32. Inner chamber 32 is preferably utilized t improve the water purification process. For example in system 62 of FIG. 7, an anode 48 is placed at the lower end of in inner tube 32, saving space (as will be described below). As another example, in order to improve the water purification process, in many embodiments, inner chamber 32 includes one or more rotating fins i.e. stirrers 42 for agitating water 38 to increase turbulence. The rotation mixes water 38, avoiding any dead volume, and allowing beam 28 to reach more micro-organisms. Fins or stirrers 42 are preferably very thin so as to avoid blocking light 28 from interacting with water 38. Processing chamber 30 does not interfere with the high flow rate of water 38 because chamber 30 has a large diameter (for example, in the range of 2 to 10 inches) and there is no pressure drop.

Note that because the prior art system 10 included the lamp 12 and quartz sleeve 14 inside the processing chamber 16, the system 10 could not utilize the inner space of chamber 16 to improve the water purification process, for example for placing the anode or rotating fins.

Preferably, lamp 56 can be operated in one or more of the following three modes:

a) continuous constant (cw) intensity (100% duty cycle)

b) quiasi cw intensity with “moderate” square pulses superimposed on a simmer. The peak power is 2 to 3 times larger than in cw operation and there is a 33% -50% duty cycle (where duty cycle equals the ratio of pulse duration to pulse period). The simmer provides very low power, sufficient to keep the lamp operating but with light output almost zero.

c) pulsed intensity with “high” narrow pulses superimposed on a simmer. The peak power is 5 to 20 times larger than in cw operation and there is a 5% -20% duty cycle.

Higher peak power allows better penetration in high turbidity water and possibly more efficient disinfection effects. The pulsed intensity mode is therefore the most preferred embodiment.

In preferred embodiments of the present invention, lamp 56 is an arc lamp. Arc lamps produce light by maintaining an electric arc across the gap between two conductors, for example two electrodes. Preferably, lamp 56 is a short arc lamp, where the tips of the two electrodes are only a few millimeters apart. Some short arc lamps have a third electrode for applying the starting pulse. Others have only two electrodes and require a triggering mechanism. Some short are lamps are designed for alternating current power (AC), and typically have two identical main electrodes. Most short arc lamps are designed for DC power and typically have two dissimilar main electrodes. Lamps designed for DC may be pulsed. Certain short arc lamps may have to be operated in a specific position so as to not overheat. The bulb of a short arc lamp is typically filled with mercury vapor, xenon (“Xe”), argon, or mercury-xenon.

The geometry of the short arc lamp is the most efficient for collimating the UV radiation. Preferably, a mercury-xenon high pressure short arc lamp is used which is the most efficient UV radiator among all short arc lamps, with the ability to radiate up to 15% of the electrical input as a UV radiation in the 200-300 nm range. The mercury-xenon high pressure short arc lamp can be operated in any of the three modes described above (cw, quasi, and pulsed). The mercury xenon high pressure short arc lamp can be pulsed efficiently and behaves very similarly to a pure xenon short are lamp. The mercury generally does not interfere or alter the electrical behavior of the lamp under pulsed conditions. It is the xenon which dictates the pulsed behavior. Suitable mercury-xenon short arc lamps for commercial use, available in the 100 to 5000 watts range, include UXM-101MD (1000 watts), UXM 2004 MD (2000 watts), and UXM 5000 MF (5000 watts), all by Ushio America of Cypress Calif.

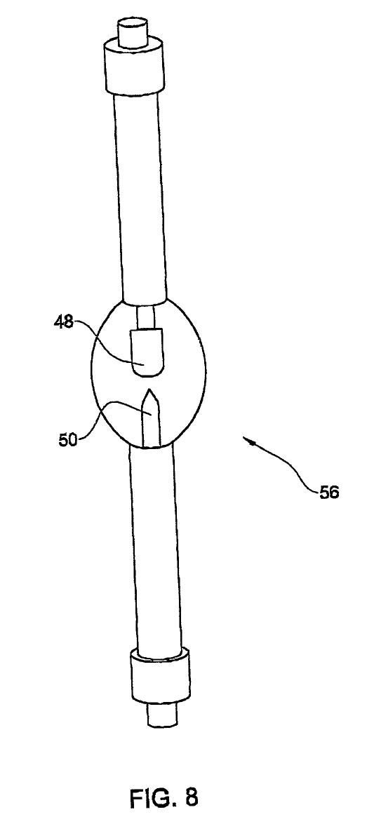

FIG. 8 shows an example of a short arc lamp that can be used as the lamp 56, enlarged to clearly show the two electrodes, anode 48 and a cathode 50. In this particular embodiment anode 48 of lamp 56 is large and bulky and cathode 50 of lamp 56 is thinner and has a needle shape.

In the particular embodiment of system 60 of FIG. 5, anode 48 (here, the larger electrode) faces upwards. The dimensions of collimator 52 are determined by the shadow of anode 48 on reflector 52 so as to collect the maximum of the light emitted by lamp 56. As an example, an eight-inch reflector 52 is illustrated in FIG. 5.

In the particular embodiment of FIG. 7, anode 48, again the larger electrode faces upwards (and as mentioned above is placed at the bottom of the inner chamber 32). System 62 also uses a collimator 64 that is a parabolic reflector the dimensions of collimator 64 are determined by the shadow of the cathode 50 (the smaller electrode) on collimator 64 so as to collect the maximum of the light emitted by the lamp 56. The dimensions of collimator 64 can therefore be smaller than collimator 52 of FIG. 5. Note that power density is determined by watts/unit area. In both systems 60 and 62, the power of lamp 56 is the same but in system 62, the collimator 64 has a smaller unit area than the collimator 52 of system 60 and therefore the power density of system 62 is higher.

FIG. 7 shows anode 48 placed at the bottom of the inner tube 32, conserving space in system 62. In other embodiments, for example where the lamp illuminates downwards as in FIG. 5, cathode 50 could be placed in inner tube 32, to conserve space. In other embodiments, cathode 50 faces upwards and/or is the larger electrode.

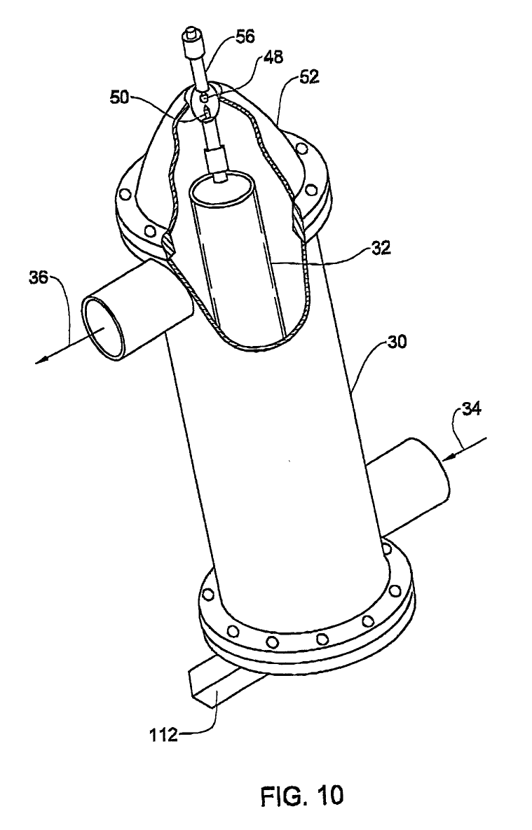

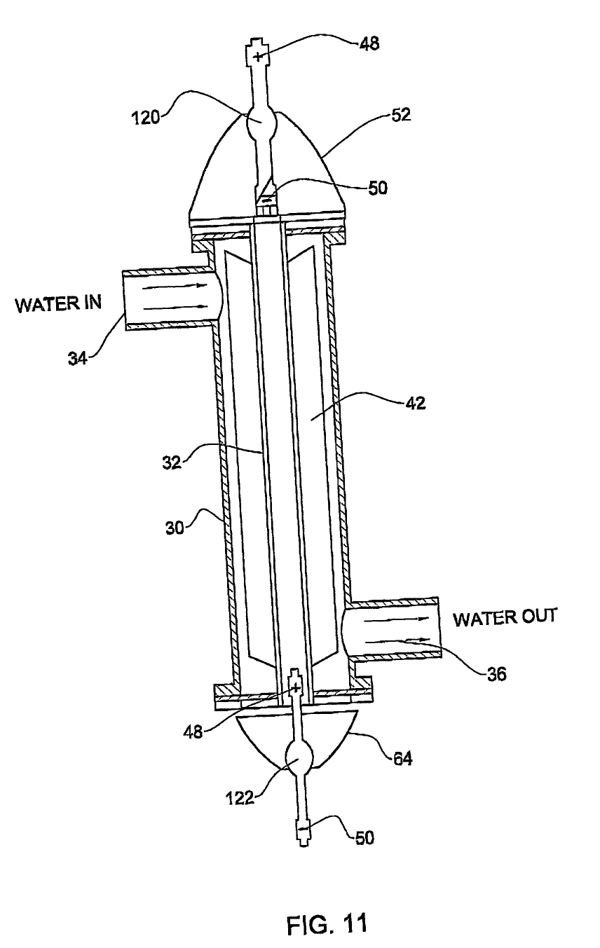

FIG. 5 also illustrates additional elements which are added to certain embodiments of system 60 including a stirrer motor 44 for operating stirrers or fins 42, a handpiece 54 for holding collimator 52 to lamp 56, a reflector mirror 46 for reflecting back the transmitted lights thereby increasing efficiency, and a cooling-down medium 57 for dissipating heat from anode 48. The handpiece 54, reflector mirror 46 and cooling unit 57 are not shown in FIG. 7 or in other figures (for example FIGS. 10, 11, and 12) representing other embodiments so as to not complicate the drawing, but the handpiece 54, reflector mirror 46 and the cooling down medium 57 can be included in certain embodiments of system 62 and/or certain embodiments corresponding to FIGS. 10, 11, and 12.

Most of the existing commercial power supplies for xenon, argon, and krypton arc lamps (short, linear DC or flashlamps) are suitable for operation of lamp 56 in the three modes of cw, quasi cw, and pulsed, with minor modifications and adaptations for voltage and current.

An example of a suitable commercially available electrical circuit in one unit which can operate lamp 56 is Part Number 891A-c manufactured by Analog Modules, Inc. of Longwood, Fla.

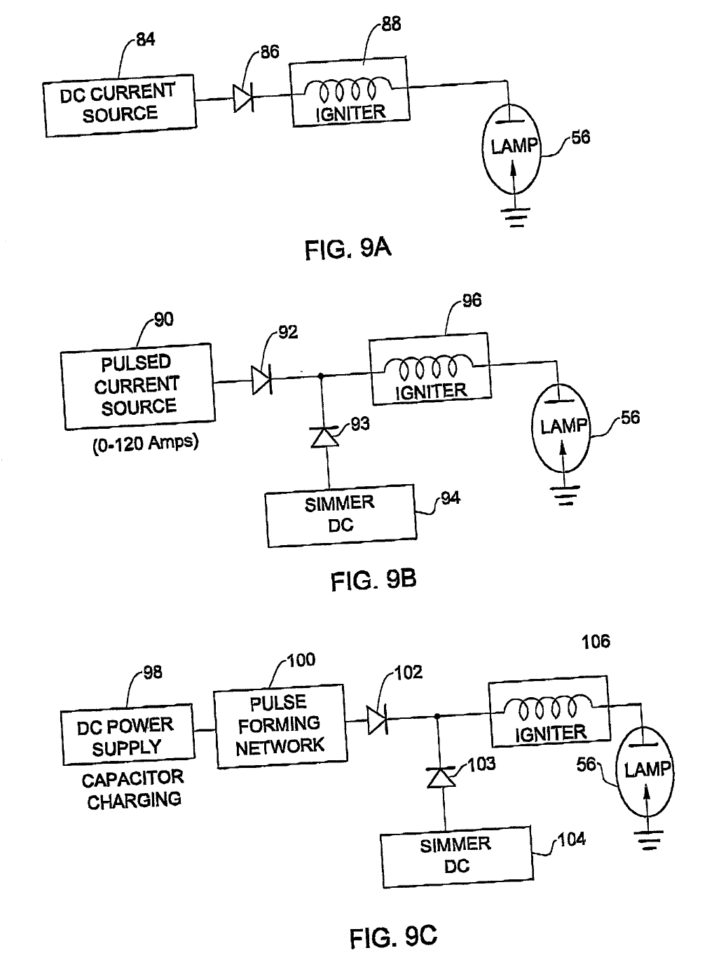

Alternatively, the electrical circuits shown in FIGS. 9a, 9b and 9c can be used to operate lamp 56 in cw, quasi cw, and pulsed modes, respectively. The electrical circuits for cw, quasi cw, and pulsed operation of lamp 56 may incorporate commercial sub-circuits.

FIG. 9a shows an example of an electrical circuit which can be used for cw operation of lamp 56.

A DC current source 84 is connected to the anode of a diode 86 whose cathode is connected to an igniter 88. Igniter 88 is connected on the other side to the anode of lamp 56. An example of a suitable DC current source 84 includes commercially available Part Number C2577 manufactured by Hamamatsu Photonics K.K. (Japan). An example of a suitable igniter 88 includes commercially available Part Number 68920 manufactured by Oriel Instruments of Stratford, Conn.

FIG. 9b shows an example of an electrical circuit which can be used for qiasi Cw operation of lamp 56. A pulsed current source (0 to 120 Amps) 90 is connected to the anode of a diode 92 whose cathode is connected to the cathode of a second diode 93 and an igniter 96. The anode of diode 93 is connected to a simmer DC 94. Igniter 96 is connected on the other side to the anode of lamp 56. An example of a suitable pulsed current source 90 includes commercially available Part Number 68920 manufactured by Oriel Instruments of Stratford, Conn. An example of a suitable igniter 96 includes commercially available Part Number 68920 manufactured by Oriel instruments of Stratford, Conn. (Pulsed current source 90 and igniter 96 are in same commercially available package by Oriel). An example of a suitable simmer DC 94 includes commercially available Part Number 861A manufactured by Analog Modules, Inc. of Longwood, Fla.

FIG. 9c shows an example of an electrical circuit that can be used for pulsed operation of lamp 56.

A DC capacitor charging power supply 98 is connected to a pulse forming network 100 which is connected on the other side to the anode of a diode 102. The cathode of diode 102 is connected to the cathode of a second diode 103 and to an igniter 106. The anode of diode 103 is connected to a simmer DC 104. Igniter 106 is connected on the other side to the anode of lamp 56. An example of a suitable capacitor charging power supply 98 includes Part Number 8800 manufactured by Analog Modules, Inc. of Longwood, Fla. An example of a suitable pulse forming network 100 includes commercially available Part Number 8800 manufactured by Analog Modules, Inc. of Longwood, Fla. (Power sapply 98 and pulse forming network 100 are in same commercial package by Analog Modules). An example of a suitable simmer DC 104 includes commercially available Part Number 861A manufactured by Analog Modules, Inc. of Longwood, Fla. An example of a suitable igniter 106 includes commercially available Part Number 68920 manufactured by Oriel Instruments of Stratford, Conn.

It should be evident that sub-circuits shown in any of FIGS. 9a, 9b, and 9c may be separated into a larger number of sub-circuits or integrated into a fewer number of sub-circuits. It should also be evident that the circuits of 9a, 9b and 9c may be integrated with each-other so that two or less circuits may be used for all three modes (cw, quasi cw, and pulsed)

In preferred embodiments of the present invention, an energy measuring device 112 is used to control the operation as shown in FIG. 10. Energy measuring device 112 is in one preferred embodiment a light sensitive detector, sensitive in the range of 200 nm to 300 nm, with an optical filter for selecting a sample of light 28 at an end of vessel 30. An example of a suitable energy measuring device 112 includes commercially available ADV 5 UV Monitor manufactured by Trojan Technologies, Inc. of London, Ontario. Energy measuring device 112 is not shown in any other figures so as to not complicate the drawings but may be present in other embodiments.

Note that stirrers 42 and stirrer motor 44 are not shown in FIG. 10 so as to not complicate the drawing. In most of the embodiments of the invention described above and below, stirrer motor 44 does not need to be placed in a specific position along vessel 30 but is placed where there is room and where motor 44 will not interfere with the rest of the water treatment system.

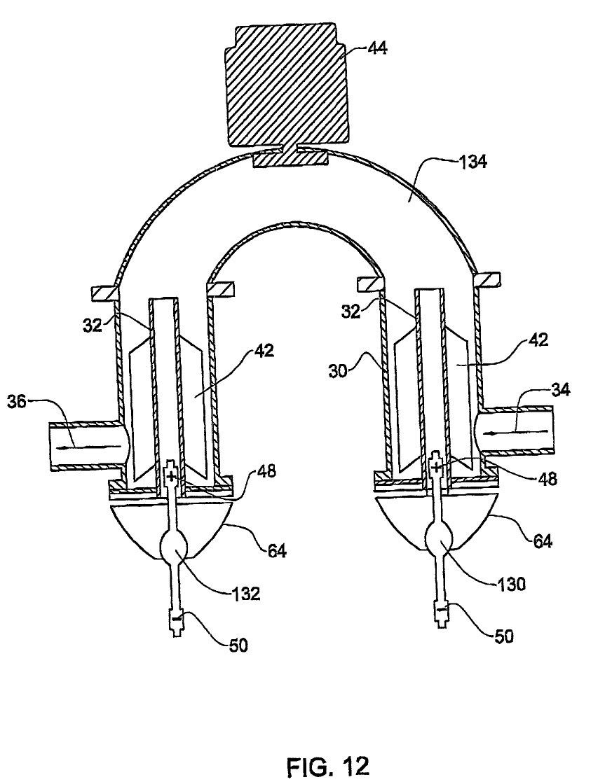

Although one lamp in preferred embodiments of the invention provides the equivalent purification as provided by approximately ten lamps in conventional prior art systems, in certain preferred embodiments, more than one lamp may be used For example, refer to FIG. 11 which shows two lamps, lamp 120 illuminating downwards and lamp 122 illuminating upwards. Again stirrer motor 44 is not shown so as to not complicate the drawing. FIG. 12 shows two lamps 130 and 132 both illuminating in the same direction. Note that there is a darkened zone 134 to which light from lamps 130 and 132 does not reach, but water 38 flows freely in zone 134. Although in FIG. 12, both lamps 130 and 132 are shown illuminating upwards, it can be appreciated that in another embodiment both lamps 130 and 132 illuminate downwards. In other embodiments, other configurations of two or more lamps may be used. In other embodiments, other orientations for axes aligning the system, for example horizontal or at an angle may be used rather than the vertical axis. The addition of extra lamps may necessitate additional windows, reflectors and/or electrical circuits.

While the invention has been described with respect to a limited number of embodiments, it will be appreciated that many variations, modifications and other applications of the invention may be made without departing from the scope of the following claims:

1. A method for purifying water contained in a vessel, comprising the steps of:
(a) disposing a source of ultraviolet light relative to the vessel for directing ultraviolet light along a major axis of said vessel; and
(b) illuminating the water with said ultraviolet light.

2. The method of claim 1, wherein said illuminating step includes the step of collimating said light.

3. The method of claim 1, wherein said light radiates in pulses.

4. The method of claim 1, wherein sad light radiates in continuous constant (cw) intensity.

5. The method of claim 1, wherein said light radiates in quasi cw intensity.

6. The method of claim 1, further comprising the step of agitating the water to increase turbulence in the water.

7. The method of claim 1, wherein said major axis is substantially vertical.

8. The method of claim 1, wherein the water flows along said major axis of the vessel.

9. A water purification system comprising,
a vessel containing the water to be purified;
at least one ultraviolet lamp, external to said vessel; and
at least one collimator for collimating ultraviolet light radiated by said at least one lamp;
wherein said light illuminates the water along a major axis of said vessel.

10. The system of claim 9, wherein said vessel is substantially aligned along a major axis wig said at least one lamp.

11. The system of claim 9, wherein said vessel has a ring shape.

12. The system of claim 9, wherein said vessel includes an inner chamber having rotating fins for increasing turbulence.

13. The system of clam 9, wherein said at least one collimator is a parabolic reflector.

14. The system of claim 13, wherein said at least one reflector has a concave surface disposed toward an electrode of said at least one lamp and is dimensioned according to a size of said electrode.

15. The system of claim 9, wherein:
said vessel includes an inner chamber, and
an electrode of said at least one lamp is placed at an end of said inner chamber.

16. The system of claim 9, further comprising at least one window through which collimated light enters said vessel.

17. The system of claim 16, wherein at least one of said at least one window is formed of quartz.

18. The system of claim 16, wherein at least one of said at least one window is formed of sapphire.

19. The system of claim 16, wherein at least one of said at least one window is coated with polymer to avoid contamination from water.

20. The system of claim 9, further comprising:
an energy measuring device to control operation.

21. The system of claim 9, wherein at least one of said ultraviolet lamps is a short arc lamp.

22. The system of claim of claim 21, wherein at leas one of said ultraviolet lamps is a high pressure short arc lamp.

23. The system of claim 22, wherein at leas one of said ultraviolet lamps is a xenon-mercury high pressure short arc lamp.

24. The system of claim 9, further comprising:
at least one electrical circuit to pulse said at least one ultraviolet lamp.

25. The system of claim 9, further comprising:
at least one electrical circuit to cause said at least one ultraviolet lamp to operate in quasi cw mode.

26. The system of claim 9, further comprising:
at least one electrical circuit to cause said at least one ultraviolet lamp to operated in continuous constant (cw) mode.

27. A water purification system comprising,
a vessel containing the water to be purified and including an inner chamber, wherein said inner chamber includes rotating fins for increasing turbulence;
at least one ultraviolet lamp, external to said vessel;
at least one electrical circuit to operate said at least one lamp in pulsed mode;
at least one collimator for collimating ultraviolet light radiated by said at least one lamp; and
at least one window through which light collimated by said at least one collimator enters said vessel;
wherein said light illuminates the water along a major axis of said vessel.
